(19) United States
(12) Patent Application Publication
(10) Pub. No.: US 2014/0354553 A1
(43) Pub. Date: Dec. 4, 2014

(54) AUTOMATICALLY SWITCHING TOUCH INPUT MODES

(71) Applicant: MICROSOFT CORPORATION, REDMOND, WA (US)

(72) Inventors: Juan Dai, Sammamish, WA (US); Daniel J. Hwang, Newcastle, WA (US); Wenqi Shen, Bellevue, WA (US); Sharath Viswanathan, Seattle, WA (US); Pu Li, Sammamish, WA (US)

(73) Assignee: MICROSOFT CORPORATION, REDMOND, WA (US)

(21) Appl. No.: 13/904,719

(22) Filed: May 29, 2013

(51) Int. Cl. G06F 3/041; G06F 3/0354; G06F 3/01

(52) U.S. Cl. CPC G06F 3/0416; G06F 3/016; G06F 3/03545
USPC 345/173

(57) ABSTRACT

Techniques are described for automatically determining a touch input mode for a computing device. The computing device can detect whether touch is being performed by a user's finger or by an object. The computing device can then enable a different interaction model depending on whether a finger or an object is detected. For example, the computing device can automatically switch to a finger touch input mode when touch input is detected using the user's finger, and automatically switch to an object touch input mode when touch input is detected using an object. The finger touch input mode can perform user interface manipulation. The object touch input mode can perform input using digital ink. Different feedback models can be provided depending on which touch input mode is currently being used.

### BACKGROUND

Mobile computing devices, such as phones and tablets, sometimes support user input via a pen or stylus in addition to a user's finger. Using a pen or stylus with such computing devices can provide an improved, or different, input experience, such as improved precision due to the smaller contact point of the pen or stylus. However, computing devices typically provide the same interaction regardless of whether the user is using a pen or stylus, or the user's finger. For example, a user can tap on the device's display (using a pen/stylus or a finger) to select an option, or the user can drag on the device's display (using a pen/stylus or a finger) to move an icon.

Some efforts have been made to provide a different input experience when using a pen or stylus. For example, some computing devices can detect a button press on a pen or stylus and perform a different function, such as bring up a menu or take a screenshot. However, requiring the user to press buttons or perform other manual tasks in order to perform a different function when using a pen or stylus can be inefficient. In addition, a user may not remember that such different functions are available, or how to activate them.

Furthermore, some computing devices only support pen input using a special pen or stylus. This can be a problem if the user loses the special pen or stylus.

Therefore, there exists ample opportunity for improvement in technologies related to efficiently providing different input experiences using computing devices.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Techniques and tools are described for automatically determining a touch input mode for a computing device. The computing device can detect whether touch is being performed by a user's finger or by an object (e.g., a conductive object). The computing device can then enable a different interaction model depending on whether a finger or an object is detected. For example, the computing device can enable a finger touch input mode when touch input is detected using the user's finger, and enable an object touch input mode when touch input is detected using a conductive object. The finger touch input mode can perform user interface manipulation. The object touch input mode can perform input using digital ink.

For example, a method can be provided for automatically determining a touch input mode. The method can be performed, at least in part, by a computing device such as a mobile phone or tablet. The method comprises receiving initiation of a touch action by a user and automatically detecting whether the touch action is received from the user using a finger or using an object (e.g., a conductive object). When the touch action is automatically detected to be using a finger, the touch input mode is switched to a finger touch input mode for receiving touch input from the user in the finger touch input mode. When the touch input is automatically detected to be using an object, the touch input mode is switched to an object touch input mode that uses digital ink, and the method further comprises receiving touch input from the user in the object touch input mode using digital ink.

For example, a method can be provided for automatically determining a touch input mode. The method can be performed, at least in part, by a computing device such as a mobile phone or tablet. The method comprises receiving initiation of a touch action by a user, automatically detecting whether the touch action is received from the user using a finger or using a conductive object, when the touch action is automatically detected to be using a finger: switching the touch input mode to a finger touch input mode and receiving touch input from the user in the finger touch input mode, when the touch input is automatically detected to be using a conductive object: switching the touch input mode to an object touch input mode that uses digital ink, where the object touch input mode only uses digital ink for input received in the object touch input mode, receiving touch input from the user in the object touch input mode using digital ink, providing haptic feedback while in the object touch input mode, the haptic feedback comprising one or more of vibration haptic feedback and electrostatic haptic feedback, and providing audio feedback while in the object touch input mode, where the haptic feedback and the audio feedback simulate writing on paper.

As another example, computing devices comprising processing units, memory, and a touch-enabled input device supporting touch by a finger and touch by an object (e.g., a conductive object) can be provided for performing operations described herein. For example, a mobile computing device, such as a mobile phone or tablet, can perform operations for automatically determining a touch input mode based on whether the computing device is touched with a finger or an object.

As described herein, a variety of other features and advantages can be incorporated into the technologies as desired.

### BRIEF DESCRIPTION OF THE DRAWINGS

FIG. 1 is a flowchart of an example method for automatically determining a touch input mode.

FIG. 2 is a flowchart of an example method for automatically determining a touch input mode including automatically switching to a finger touch input mode or an object touch input mode.

FIG. 3 depicts an example implementation for automatically switching to a finger touch input mode when touch by a finger is detected.

FIG. 4 depicts an example implementation for automatically switching to an object touch input mode when touch by an object is detected.

FIG. 5 depicts an example implementation for automatically detecting a touch action and automatically switching a touch input mode.

FIG. 6 is a diagram of an exemplary computing system in which some described embodiments can be implemented.

FIG. 7 is an exemplary mobile device that can be used in conjunction with the technologies described herein.

FIG. 8 is an exemplary cloud-support environment that can be used in conjunction with the technologies described herein.

### DETAILED DESCRIPTION

### Example 1

### Overview

As described herein, various techniques and solutions can be applied for automatically detecting whether touch input is using a person's finger or an object (e.g., a conductive object). If the touch input is detected using the person's finger, then the touch input mode of the computing device can be automatically placed into a finger touch input mode. The finger touch input mode performs user interface manipulation using a multi-touch display. For example, using the finger touch input mode the user can select buttons, icons, or other items, scroll, drag, pinch, zoom, and perform other finger touch actions. If, however, the touch input is detected using an object (that is not the user's finger), such as a pen, stylus, car keys, or other object (e.g., another type of conductive object), the touch input mode of the computing device can be automatically placed into an object touch input mode that uses digital ink (e.g., that only uses digital ink). Using the object touch input mode, the user can write or draw on the display using digital ink.

The touch input mode of the computing device (e.g., mobile phone or tablet) can be automatically selected. For example, when the user's finger or an object is in close proximity (or touches) the display of the computing device, then the computing device can automatically detect whether the user's finger or an object is being used and switch the touch input mode accordingly.

The finger touch input mode and the object touch input mode can be mutually exclusive. For example, the computing device can automatically enable the touch input mode corresponding to the type of touch input (finger touch input mode for touch input using the person's finger and object touch input mode for touch input using a conductive object). When the touch input mode is enabled, then the user can perform (e.g., only perform) finger touch input (e.g., user interface manipulation operations) while using the user's finger. When the object touch input mode is enabled, the user can perform (e.g., only perform) digital ink input while using the object.

In some implementations, the touch input modes provide feedback. For example, a different feedback model can be provided depending on the current touch input mode (e.g., depending on whether the current touch input mode is the finger touch input mode or the object touch input mode). In a specific implementation, the object touch input mode provides haptic feedback (e.g., vibration haptic feedback and/or electrostatic haptic feedback), audio feedback, and visual feedback (e.g., the appearance of writing ink on the display) to simulate the feeling of writing on paper.

In some implementations, an object refers to a conductive object that can be recognized by a capacitive touchscreen. The object in these implementations does not have to be a special purpose pen or stylus. In these implementations, any type of conductive object that is pointy or otherwise has a smaller contact area where it is in contact with the touchscreen than a person's finger can be recognized by the capacitive touchscreen (e.g., and be detected as an object and not a person's finger). Examples of such conductive objects (e.g., conductive pointy objects) are ballpoint pens, car keys, paper clips, and other types of conductive objects.

### Example 2

### Touch Input Mode

In the technologies described herein, computing devices (e.g., a mobile computing device, such as a phone or tablet) support a touch input mode that can be set to either a finger touch input mode or an object touch input mode.

For example, a computing device can be equipped with touchscreen technology that is capable of distinguishing between touch by a person's finger and touch by an object (that is not a person's finger). In some implementations, the touchscreen technology (e.g., as incorporated into a display of a mobile phone or tablet device) is capable of distinguishing between touch by a person's finger and touch by a conductive object (e.g., a conductive pointy object) that is not a person's finger. For example, the conductive object can be a pen or stylus that is specially designed to work with a capacitive touchscreen and/or digitizer, a traditional ball-point pen, car keys, or any other pointy conductive object.

In some implementations, detecting whether touch is received via a finger or an object uses one or more parameters. The parameters can comprise a location on a touchscreen (e.g., x and y coordinates), a distance from the touchscreen (e.g., a z coordinate), a size of the touch area (e.g., a diameter of the touch area), an angle of the finger or object performing the touch, a number of fingers and/or objects performing the touch, etc. The parameters can be obtained from a touchscreen device and/or associated components (e.g., digitizer components) of a computing device.

In some implementations, detecting whether touch is received via a finger or an object comprises comparing one or more parameters against one or more threshold values. For example, a number of pre-determined threshold values can be determined for different types of conductive objects and for a person's finger. Touch by a person's finger can then be distinguished from touch by a conductive object by comparing one or more parameters against the pre-determined threshold values.

In a specific implementation, at least a size parameter is obtained. The size parameter indicates a diameter of a touch area associated with a touch action. In the specific implementation, the size parameter is compared with one or more pre-determined thresholds to determine whether the touch is via a finger or via a conductive object. For example, if the pre-determined threshold is 1 cm, and if the size parameter indicates a diameter of a touch area of 1.5 cm, then the touch can be determined to be via a person's finger. If, however, the size parameter indicates a diameter of the touch area of 5 mm, then the touch can be determined to be via a conductive object. Alternatively, more than one pre-determined threshold and/or ranges can be used (e.g., different thresholds to distinguish between different types of conductive objects, such as a pen, stylus, car key, etc.).

### Example 3

### Finger Touch Input Mode

A finger touch input mode can be enabled when touch by a person's finger is detected. For example, a computing device can determine that a touch action has been initiated by a user's finger instead of by an object (e.g., a pen or stylus, ball-point pen, car keys, or another conductive object). In some implementations, the touch action is initiated when the user's finger is near (e.g., in close proximity) to the surface of a display of the device and/or when the user's finger touches the surface of the display of the device.

When the finger touch input mode is enabled (e.g., when the touch input mode of the computing device is set to the finger touch input mode), touch input using the user's finger will manipulate the user interface, as would normally be done with a multi-touch user interface. For example, when the finger touch input mode is enabled, the user can tap with the user's finger to select items, launch applications, select on-screen keyboard keys, etc. As another example, when the finger touch input mode is enabled, the user can perform touch gestures using the user's finger (or multiple fingers if the gesture is a multi-touch gesture), such as scrolling, swiping, pinching, stretching, rotating, and/or other touch user interface manipulation actions that can be performed with the user's finger.

### Example 4

### Object Touch Input Mode

An object touch input mode can be enabled when touch by an object is detected. For example, a computing device can determine that a touch action has been initiated by a conductive object (e.g., a pen or stylus, ball-point pen, car keys, or another conductive object) instead of by a user's finger. In some implementations, the touch action is initiated when the conductive object is near (e.g., in close proximity) to the surface of a display of the device and/or when the conductive object touches the surface of the display of the device.

When the object touch input mode is enabled (e.g., when the touch input mode of the computing device is set to the object touch input mode), touch input using an object will perform digital ink input. For example, the user can use a pen or stylus to write or draw using digital ink. The input digital ink content can be recognized (e.g., using handwriting recognition) or it can remain as handwritten digital ink content.

For example, a user can launch an application (e.g., a note taking application) on the user's mobile phone using the user's finger to tap on the application icon. Once the application has been launched, the user can pick up a pen or stylus (or another object, such as a ballpoint pen or the user's car keys). When the mobile phone detects that touch input will be initiated using the object (e.g., by detecting that the object is near, or touching, the display), the mobile phone can automatically switch to the object touch input mode. Touch input by the user will then be input in the object touch input mode, which uses digital ink.

By automatically switching to the object touch input mode when touch input using an object is detected, the user can quickly and easily enter digital ink content using a pen or stylus (or another type of object, such as a conductive pointy object). Using a pen or stylus, or another type of object, can provide more precise input, which is beneficial when using digital ink (e.g., for improved drawing precision, improved handwriting recognition accuracy, etc.). In addition, the user does not have to select a physical button or onscreen icon, or change a system setting, to switch between a finger touch input mode and an object touch input mode.

Digital ink refers to the ability to write or draw on a computing device. For example, a computing device, such as a mobile phone or tablet computer, can be equipped with technology that receives input from a user using a pen, stylus, or another object to draw on the display of the computing device (e.g., using touchscreen and/or digitizer technology). Other types of computing devices can also be used for digital ink input, such as a laptop or desktop computer equipped with an input device supporting digital ink.

Digital ink can be used to simulate traditional pen and paper writing. For example, a user can use a stylus, pen, or another object, to write on display as the user would write with traditional pen and paper. The content written by the user can remain in written format and/or converted to text (e.g., using handwriting recognition technology).

### Example 5

### Feedback in Touch Input Modes

When a person writes or draws with a traditional pen or pencil on paper, the contact between the pen or pencil and the paper provides feedback. The feedback can be in the feel of the pen or pencil on the paper (e.g., friction or texture), in the sound of the writing or drawing, and/or in the visual appearance of the writing or drawing content on the paper. Such feedback can provide an improved writing or drawing experience for the user.

Computing devices typically have a smooth glass display on which the user enters touch input, using either the user's finger or an object, such as a stylus or pen. When entering digital ink input using an object (e.g., a pen, stylus, or another conductive object), the experience may be confusing or uncomfortable for the user due to the lack of feedback when writing or drawing on the smooth display.

In order to provide a writing or drawing experience on the display of a computing device that is similar to using pen/pencil and paper, different types of feedback can be provided (e.g., haptic, audio, and/or visual feedback). Vibration feedback is one type of haptic feedback that can be provided. For example, when a user writes or draws on the display using an object (e.g., a pen, stylus, ballpoint pen, car keys, etc.) in an object touch input mode using digital ink, the computing device can vibrate. Vibration feedback can provide at least a portion of the experience of writing with pen/pencil on paper (e.g., it can simulate friction or texture). The vibration feedback can be provided only while the user is moving the object across the display (e.g., it can start when the object is moving and stop when the object stops). In addition, different or varying levels of vibration can be provided (e.g., more vibration, in strength and/or frequency, when the user moves faster and/or presses harder).

Electrostatic feedback is another type of haptic feedback that can be provided. For example, when a user writes or draws on the display using an object (e.g., a pen, stylus, ballpoint pen, car keys, etc.) in an object touch input mode using digital ink, the computing device can provide an electrostatic field which creates the feeling of friction. The electrostatic feedback can provide at least a portion of the experience of writing with pen/pencil on paper (e.g., it can simulate friction or texture). The electrostatic feedback can be provided only while the user is moving the object across the display (e.g., it can start when the object is moving and stop when the object stops). In addition, different or varying levels of electrostatic feedback can be provided

Audio feedback can also be provided. For example, when a user writes or draws on the display using an object in an object touch input mode using digital ink, the computing device can provide an audio indication, such as the sound of a pen or pencil writing on paper or on another type of surface. The audio feedback can be provided only while the user is moving the object across the display (e.g., it can start when the object is moving and stop when the object stops). In addition, the audio feedback can vary (e.g., varying sound and/or volume corresponding to speed, pressure, surface type, etc.).

Visual feedback can also be provided. For example, when a user writes or draws on the display using an object in an object touch input mode using digital ink, the computing device can provide a visual indication, such as the appearance of ink or pencil being written or drawn on the display (e.g., with varying weight or thickness corresponding to pressure, speed, etc.).

Combinations of feedback can be provided. For example, haptic feedback (e.g., vibration and/or electrostatic haptic feedback) can be provided along with audio and/or visual feedback.

Feedback can also be provided when the user is entering touch input using the user's finger. For example haptic feedback (e.g., vibration and/or electrostatic) can be provided in the finger touch input mode. The haptic feedback can vary depending on what action the user is performing (e.g., tapping, scrolling, pinching, zooming, swiping, etc.). Audio and/or visual feedback can also be provided in the finger touch input mode).

Feedback can be provided depending on touch input mode (e.g., different types or combinations of feedback depending on which touch input mode is currently being used). For example, at least haptic and audio feedback can be provided when the user is writing or drawing with an object in the object touch input mode to simulate the writing experience when using pen and paper, and at least audio feedback can be provided when the user is entering touch input in the finger touch input mode (e.g., clicking, tapping, and/or dragging sounds). In some implementations, haptic feedback (e.g., vibration and/or electrostatic haptic feedback) is provided only when the object touch input mode is enabled (and not when using the finger touch input mode).

### Example 6

### Methods for Automatically Determining a Touch Input Mode

In any of the examples herein, methods can be provided for automatically determining a touch input mode. For example, a computing device can automatically detect whether a touch action is being performed using a finger or using an object and automatically set the touch input mode accordingly. For example, if the touch is detected to be using a person's finger, then the touch input mode can be automatically set to a finger touch input mode. On the other hand, if the touch is detected to be using an object (e.g., a conductive pointy object), then the touch input mode can be automatically set to an object touch input mode. The finger touch input mode and the object touch input mode treat touch input differently. In some implementations, the finger touch input mode performs user interface manipulation (e.g., selecting user interface elements, such as buttons, icons, and onscreen keyboard keys, scrolling, dragging, pinching, zooming, and other user interface manipulation tasks) while the object touch input mode enters digital ink content (e.g., text or drawing content entered in digital ink).

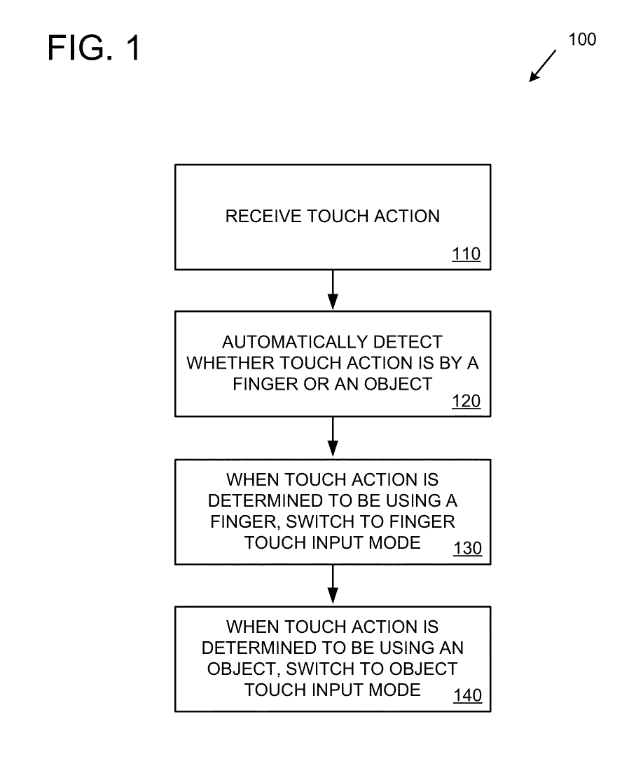

FIG. 1 is a flowchart of an example method 100 for automatically determining a touch input mode. The example method 100 can be performed, at least in part, by a computing device, such as a mobile phone or tablet.

At 110, a touch action is received by a computing device (e.g., by a touchscreen display of the computing device). For example, the touch action can be received by a computing device from a user. The touch action can be received when the user initiates touch using the user's finger (e.g., when the user's finger touches, or nears, an input device, such as a touchscreen, of the computing device) or using an object (e.g., when the object touches, or nears, an input device, such as a touchscreen, of the computing device).

At 120, the computing device automatically detects whether the touch action is received from the user using a finger or using an object. For example, one or more parameters can be received (e.g., x and y position, size, angle, and/or other parameters). The parameters can be compared to thresholds and/or ranges to determine whether the touch is by a finger or an object. In a specific implementation, at least a size parameter (e.g., indicating a diameter of the touch area) is compared to one or more thresholds to distinguish between touch by a finger and touch by an object.

At 130, when the touch action is determined to be using a finger, the touch input mode is automatically switched to a finger touch input mode. While in the finger touch input mode, touch input received from the user using the user's finger can perform user interface manipulation actions. For example, user interface manipulation can be a default state for the finger touch input mode.

At 140, when the touch action is determined to be using an object, the touch input mode is automatically switched to an object touch input mode. While in the object touch input mode, touch input received from the user using the object can enter digital ink content.

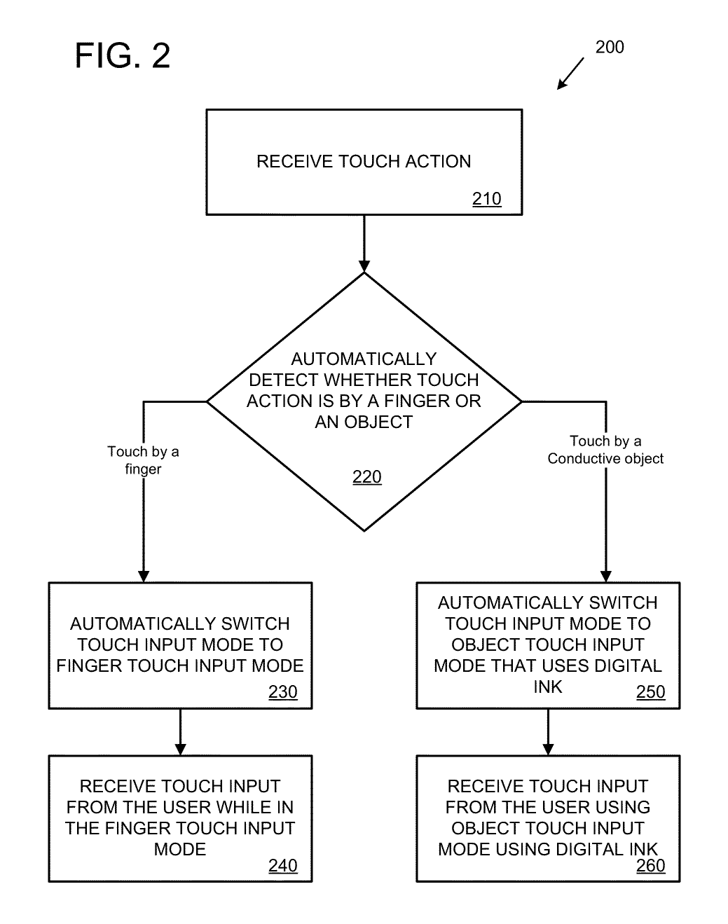

FIG. 2 is a flowchart of an example method 200 for automatically determining a touch input mode, including automatically switching to a finger touch input mode or an object touch input mode

At 210, a touch action is received by a computing device (e.g., by a touchscreen display of the computing device). For example, the touch action can be received when a user of the computing device initiates touch using the user's finger (e.g., when the user's finger touches, or nears, an input device, such as the touchscreen, of the computing device) or using an object (e.g., when the object touches, or nears, an input device, such as the touchscreen, of the computing device).

At 220, the computing device automatically detects whether the touch action is received from the user using a finger or using an object. For example, one or more parameters can be received (e.g., x and y position, size, angle, and/or other parameters). The parameters can be compared to thresholds and/or ranges to determine whether the touch is by a finger or an object. In a specific implementation, at least a size parameter (e.g., indicating a diameter of the touch area) is compared to one or more thresholds to distinguish between touch by a finger and touch by an object.

If the touch action is performed using a finger (and not an object), as automatically detected at 220, then the method proceeds to 230 where the computing device automatically switches the touch input mode to a finger touch input mode. At 240, touch input is received from the user while the computing device remains in the finger touch input mode (e.g., while the user continues to perform touch activity using the user's finger). While in the finger touch input mode, touch input received from the user using the user's finger can perform user interface manipulation actions. For example, user interface manipulation can be a default state for the finger touch input mode.

While in the finger touch input mode (e.g., at 240), feedback can be provided. For example, feedback can be provided in the finger touch input mode according to a first feedback model (e.g., a feedback model that includes audio feedback for finger touch actions, such as tapping, selecting, scrolling, swiping, dragging, etc.).

If the touch action is performed using an object (and not a finger), as automatically detected at 220, then the method proceeds to 250 where the computing device automatically switches the touch input mode to an object touch input mode that uses digital ink. At 260, touch input is received from the user while the computing device remains in the object touch input mode (e.g., while the user continues to enter digital ink content using the object, such as a stylus, ballpoint pen, car keys, or another conductive object).

While in the object touch input mode (e.g., at 260), feedback can be provided. For example, feedback can be provided in the object touch input mode according to a second feedback model (e.g., a feedback model that includes haptic feedback and audio feedback).

The computing device can automatically perform the detection (e.g., at 120 or 220) using software and/or hardware components of the computing device. For example, a software component of the computing device (e.g., an operating system component) can receive one or more parameters from a touchscreen of the computing device (e.g., x and y position, size, angle, and/or other parameters). The software component can then compare one or more of the received parameters against one or more thresholds and/or ranges and automatically make a determination of whether the touch is by a finger or by an object.

When touch activity is detected using a finger, the touch input mode is automatically switched to the finger touch input mode. For example, the finger touch input mode can be the default touch input mode when a finger touch is detected. In some implementations, the finger touch input mode only supports performing user interface manipulation actions. In other implementations, however, the user can manually change (e.g., temporarily) how the finger touch input mode operates. For example, if the user wants to enter digital ink content while in the finger touch input mode, the user can manually (e.g., using a button or software control) change the operation of the finger touch input mode to enter digital ink content while using the user's finger (instead of performing user interface manipulation).

When touch activity is detected using an object, the touch input mode is automatically switched to the object touch input mode that receives touch input using digital ink. For example, the object touch input mode can be the default touch input mode when an object touch is detected. In some implementations, the object touch input mode only supports digital ink input. In other implementations, however, the user can manually (e.g., temporarily) change how the object touch mode operates. For example, if the user wants to perform user interface manipulation actions while in the object touch input mode, the user can manually change (e.g., using a button or software control) the operation of the object touch input mode to perform user interface manipulation actions while using the object to perform touch actions.

### Example 7

### Example Implementations for Automatically Switching Touch Input Modes

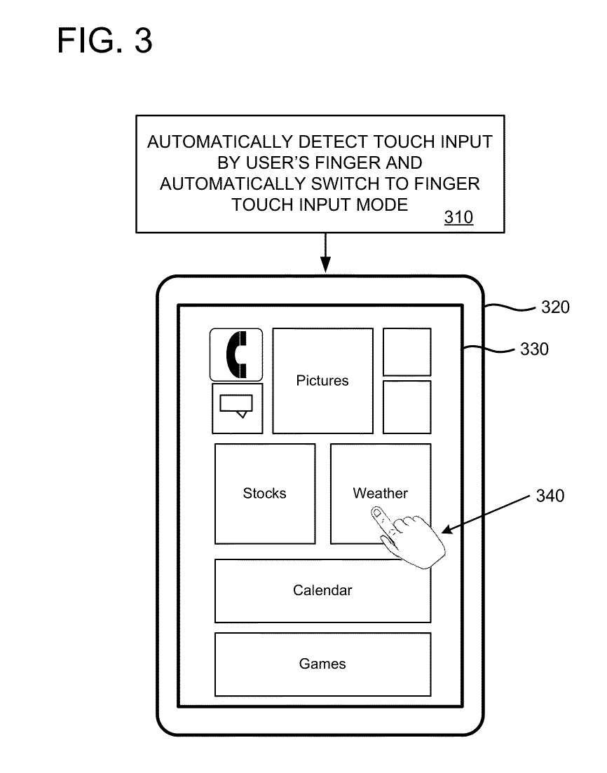

FIG. 3 depicts an example implementation for automatically switching to a finger touch input mode when touch by a finger is detected. In FIG. 3, a computing device 320 (e.g., a phone, tablet, or other type of computing device) is depicted. The computing device 320 comprises a display 330 (e.g., a touchscreen display) that is currently presenting a graphical user interface (e.g., a start screen or desktop).

As depicted in FIG. 3, the user of the computing device 320 has touched the display 330 with the user's finger 340. The computing device 320 (e.g., via software and/or hardware components of the computing device 320) has automatically detected the touch input by the user's finger 340 and in response the computing device 320 has automatically switched to a finger touch input mode 310. While in the finger touch input mode, touch input received from the user using the user's finger 340 will perform (e.g., by default) user interface manipulation actions (e.g., launching applications, viewing pictures, making phone calls, viewing calendars, typing on an onscreen keyboard, and/or other user interface manipulation actions that can be performed using a touchscreen).

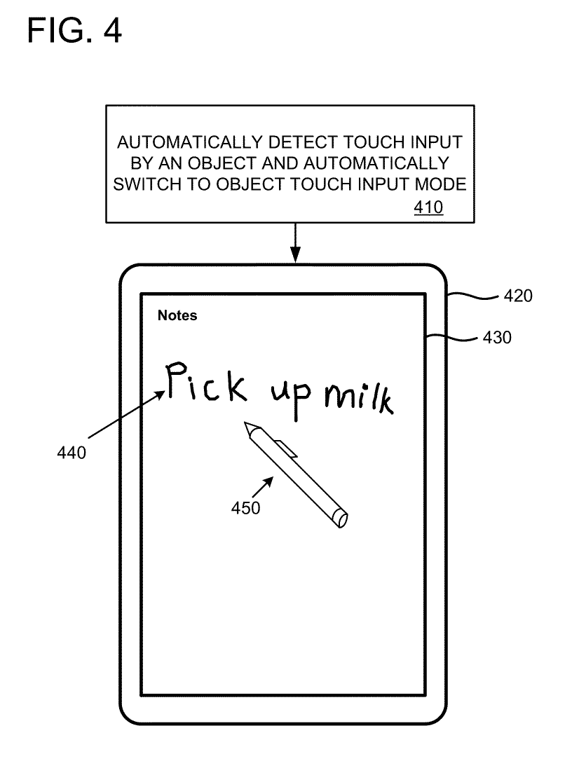

FIG. 4 depicts an example implementation for automatically switching to an object touch input mode when touch by an object is detected. In FIG. 4, a computing device 420 (e.g., a phone, tablet, or other type of computing device) is depicted. The computing device 420 comprises a display 430 (e.g., a touchscreen display) that is currently presenting a note taking application within a graphical user interface.

As depicted in FIG. 4, the user of the computing device 420 has touched the display 430 with a conductive pen-like object 450 (e.g., a pen, stylus, or ballpoint pen). The computing device 420 (e.g., via software and/or hardware components of the computing device 420) has automatically detected the touch input by the object 450 and in response the computing device 420 has automatically switched to an object touch input mode 410. While in the object touch input mode, touch input received from the user using the object 450 will enter digital ink content. For example, in the display 430, the user has entered a note in digital ink, “Pick up milk” 440. The digital ink content can remain in handwritten format (e.g., as depicted at 440) or it can be recognized using handwriting recognition technology (e.g., converted to plain text).

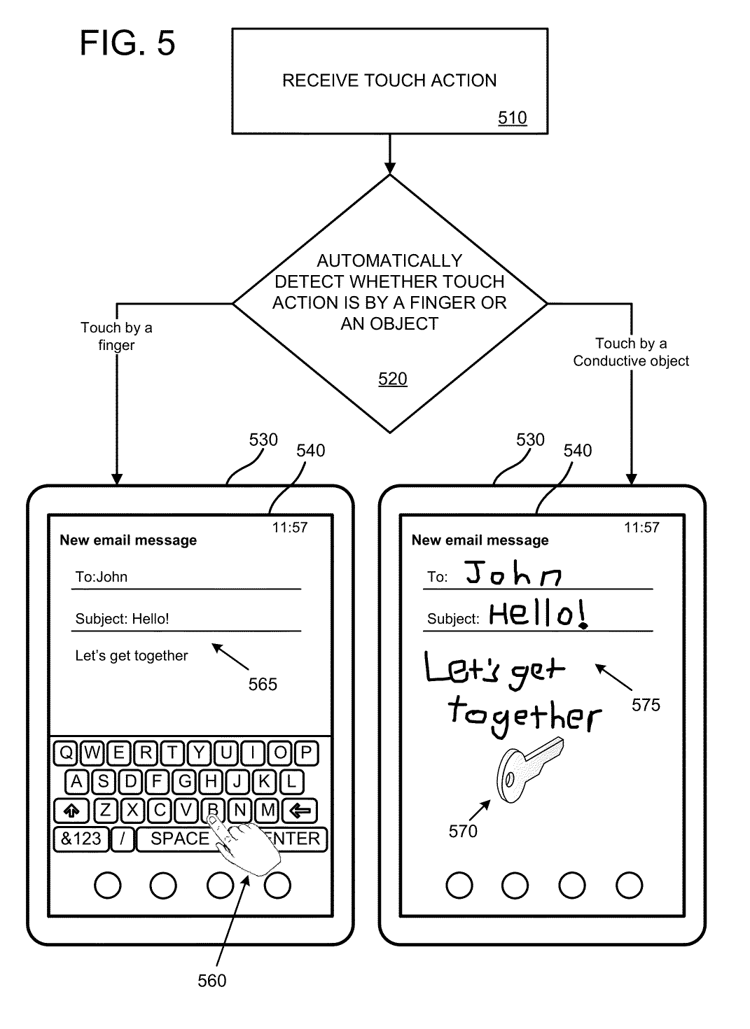

FIG. 5 depicts an example implementation for automatically detecting a touch action and automatically switching a touch input mode. In FIG. 5, a computing device 530 (e.g., a phone, tablet, or other type of computing device) is depicted. The computing device 530 comprises a display 540 (e.g., a touchscreen display) that is capable of receiving touch input from a user.

When the display 540 is touched by the user, the computing device 530 receives the touch action 510 and automatically detects whether the touch action is by a finger or by an object 520. When the touch action is by a finger, the computing device 530 automatically switches to a finger touch input mode. When the touch action is by an object, the computing device 530 automatically switches to an object touch input mode.

FIG. 5 also depicts how the computing device 530 can support both the finger touch input mode and the object touch input mode using an email application as an example. When the touch action is detected (at 520) using the user's finger 560, the computing device 530 automatically switches to the finger touch input mode. Using the email application as an example, the computing device 530 displays an on-screen keyboard which the user can then use to enter the content of an email message 565 using the user's finger 560.

While in the finger touch input mode, the computing device 530 can also provide feedback. For example, the finger touch input mode can provide feedback according to a first feedback model (e.g., audio feedback comprising clicking sounds when the user selects keys on the onscreen keyboard). The type of feedback provided in the finger touch input mode can be different from the type of feedback provided in the object touch input mode.

When the touch action is detected (at 520) using an object 570, the computing device 530 automatically switches to the object touch input mode. Using the email application as an example, the user enters digital ink content 575 for the email message using the object (a key 570 in this example). The computing device can perform handwriting recognition on the digital ink content 575 to convert the handwritten content into plain text when sending the email message.

While in the object touch input mode, the computing device 530 can also provide feedback. For example, in the object touch input mode feedback can be provided according to a second feedback model (e.g., a combination that includes at least haptic and audio feedback that simulates the experience of writing on paper). The type of feedback provided in the object touch input mode can be different from the type of feedback provided in the finger touch input mode.

As depicted in FIG. 5, the computing device 530 can automatically detect whether the user is using a finger or an object and automatically switch the touch input mode accordingly. By using this technique, the user does not have to take any additional action (e.g., operation of a manual button or manual selection of an icon or setting) other than touching the computing device 530 with the user's finger or the object. In addition, by automatically switching the touch input mode, the computing device can (e.g., by default) receive input in a mode that is appropriate to the type of touch (e.g., user interface manipulation for finger touch and digital ink for object touch). Furthermore, in some implementations the computing device 530 can detect touch by a conductive pointy object (e.g., the car keys as depicted at 570), which allows the user to use an available conductive pointy object (e.g., even if the user loses a special pen or stylus provided with the computing device 530).

### Example 8

### Computing Systems

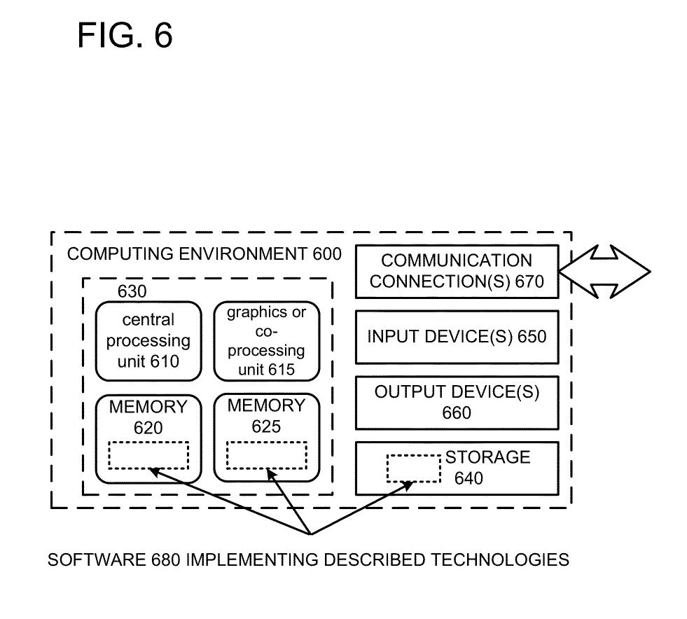

FIG. 6 depicts a generalized example of a suitable computing system 600 in which the described innovations may be implemented. The computing system 600 is not intended to suggest any limitation as to scope of use or functionality, as the innovations may be implemented in diverse general-purpose or special-purpose computing systems.

With reference to FIG. 6, the computing system 600 includes one or more processing units 610, 615 and memory 620, 625. In FIG. 6, this basic configuration 630 is included within a dashed line. The processing units 610, 615 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 6 shows a central processing unit 610 as well as a graphics processing unit or co-processing unit 615. The tangible memory 620, 625 may be volatile memory (e.g., registers, cache, RAM), non-volatile memory (e.g., ROM, EEPROM, flash memory, etc.), or some combination of the two, accessible by the processing unit(s). The memory 620, 625 stores software 680 implementing one or more innovations described herein, in the form of computer-executable instructions suitable for execution by the processing unit(s).

A computing system may have additional features. For example, the computing system 600 includes storage 640, one or more input devices 650, one or more output devices 660, and one or more communication connections 670. An interconnection mechanism (not shown) such as a bus, controller, or network interconnects the components of the computing system 600. Typically, operating system software (not shown) provides an operating environment for other software executing in the computing system 600, and coordinates activities of the components of the computing system 600.

The tangible storage 640 may be removable or non-removable, and includes magnetic disks, magnetic tapes or cassettes, CD-ROMs, DVDs, or any other medium which can be used to store information and which can be accessed within the computing system 600. The storage 640 stores instructions for the software 680 implementing one or more innovations described herein.

The input device(s) 650 may be a touch input device such as a keyboard, mouse, pen, or trackball, a voice input device, a scanning device, or another device that provides input to the computing system 600. For video encoding, the input device(s) 650 may be a camera, video card, TV tuner card, or similar device that accepts video input in analog or digital form, or a CD-ROM or CD-RW that reads video samples into the computing system 600. The output device(s) 660 may be a display, printer, speaker, CD-writer, or another device that provides output from the computing system 600.

The communication connection(s) 670 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 9

### Mobile Device

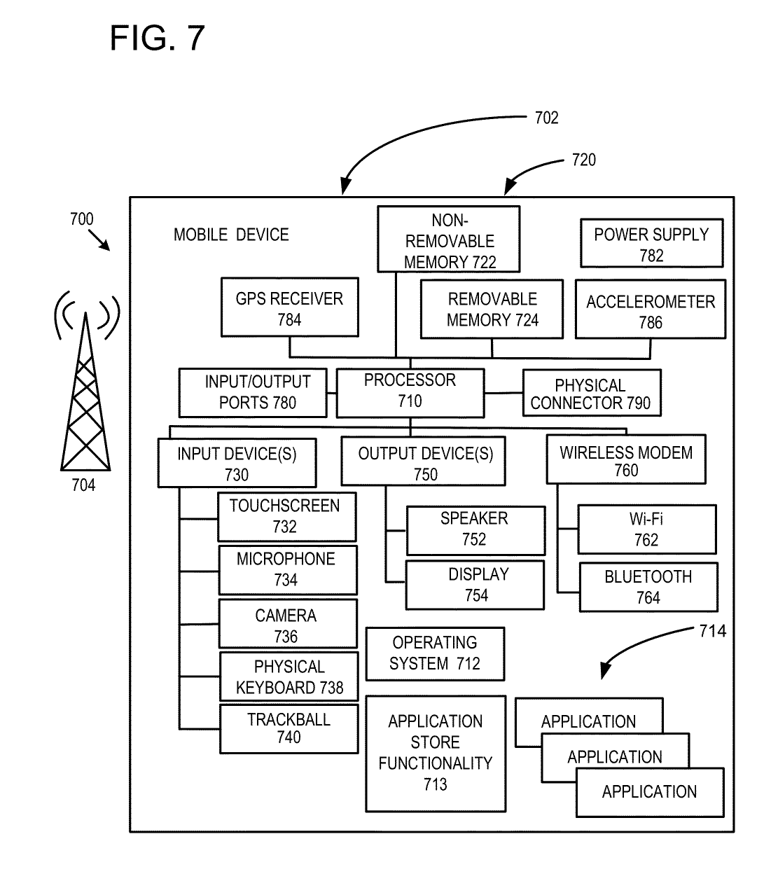

FIG. 7 is a system diagram depicting an exemplary mobile device 700 including a variety of optional hardware and software components, shown generally at 702. Any components 702 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 704, such as a cellular, satellite, or other network.

The illustrated mobile device 700 can include a controller or processor 710 (e.g., signal processor, microprocessor, ASIC, or other control and processing logic circuitry) for performing such tasks as signal coding, data processing, input/output processing, power control, and/or other functions. An operating system 712 can control the allocation and usage of the components 702 and support for one or more application programs 714. The application programs can include common mobile computing applications (e.g., email applications, calendars, contact managers, web browsers, messaging applications), or any other computing application. Functionality 713 for accessing an application store can also be used for acquiring and updating application programs 714.

The illustrated mobile device 700 can include memory 720. Memory 720 can include non-removable memory 722 and/or removable memory 724. The non-removable memory 722 can include RAM, ROM, flash memory, a hard disk, or other well-known memory storage technologies. The removable memory 724 can include flash memory or a Subscriber Identity Module (SIM) card, which is well known in GSM communication systems, or other well-known memory storage technologies, such as “smart cards.” The memory 720 can be used for storing data and/or code for running the operating system 712 and the applications 714. Example data can include web pages, text, images, sound files, video data, or other data sets to be sent to and/or received from one or more network servers or other devices via one or more wired or wireless networks. The memory 720 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 700 can support one or more input devices 730, such as a touchscreen 732, microphone 734, camera 736, physical keyboard 738 and/or trackball 740 and one or more output devices 750, such as a speaker 752 and a display 754. Other possible output devices (not shown) can include piezoelectric or other haptic output devices. Some devices can serve more than one input/output function. For example, touchscreen 732 and display 754 can be combined in a single input/output device.

The input devices 730 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 712 or applications 714 can comprise speech-recognition software as part of a voice user interface that allows a user to operate the device 700 via voice commands. Further, the device 700 can comprise input devices and software that allows for user interaction via a user's spatial gestures, such as detecting and interpreting gestures to provide input to a gaming application.

A wireless modem 760 can be coupled to an antenna (not shown) and can support two-way communications between the processor 710 and external devices, as is well understood in the art. The modem 760 is shown generically and can include a cellular modem for communicating with the mobile communication network 704 and/or other radio-based modems (e.g., Bluetooth 764 or Wi-Fi 762). The wireless modem 760 is typically configured for communication with one or more cellular networks, such as a GSM network for data and voice communications within a single cellular network, between cellular networks, or between the mobile device and a public switched telephone network (PSTN).

The mobile device can further include at least one input/output port 780, a power supply 782, a satellite navigation system receiver 784, such as a Global Positioning System (GPS) receiver, an accelerometer 786, and/or a physical connector 790, which can be a USB port, IEEE 1394 (FireWire) port, and/or RS-232 port. The illustrated components 702 are not required or all-inclusive, as any components can be deleted and other components can be added.

### Example 10

### Cloud-Supported Environment

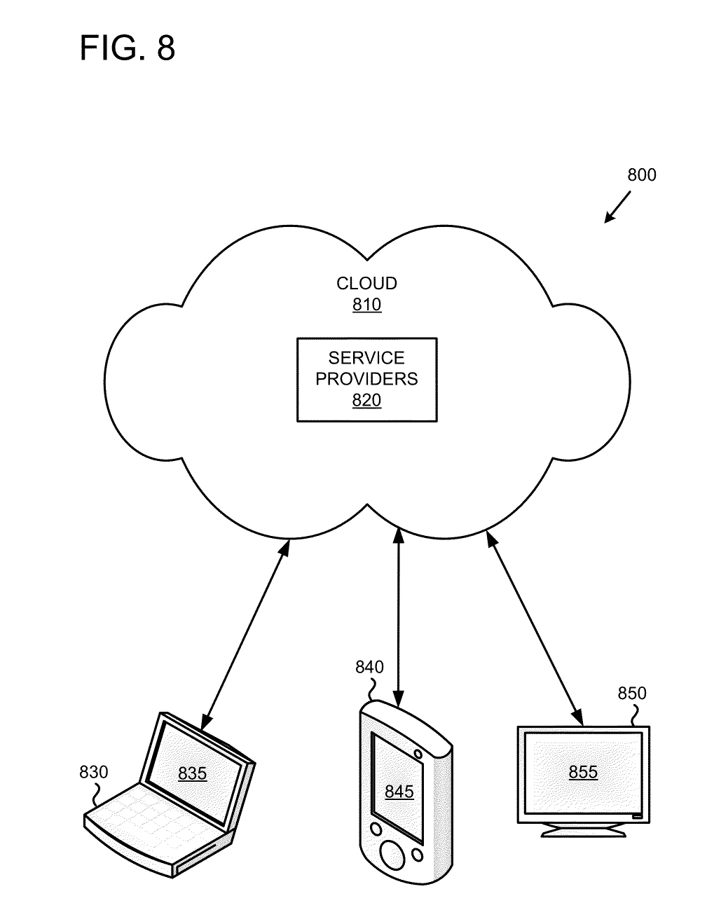

FIG. 8 illustrates a generalized example of a suitable implementation environment 800 in which described embodiments, techniques, and technologies may be implemented. In the example environment 800, various types of services (e.g., computing services) are provided by a cloud 810. For example, the cloud 810 can comprise a collection of computing devices, which may be located centrally or distributed, that provide cloud-based services to various types of users and devices connected via a network such as the Internet. The implementation environment 800 can be used in different ways to accomplish computing tasks. For example, some tasks (e.g., processing user input and presenting a user interface) can be performed on local computing devices (e.g., connected devices 830, 840, 850) while other tasks (e.g., storage of data to be used in subsequent processing) can be performed in the cloud 810.

In example environment 800, the cloud 810 provides services for connected devices 830, 840, 850 with a variety of screen capabilities. Connected device 830 represents a device with a computer screen 835 (e.g., a mid-size screen). For example, connected device 830 could be a personal computer such as desktop computer, laptop, notebook, netbook, or the like. Connected device 840 represents a device with a mobile device screen 845 (e.g., a small size screen). For example, connected device 840 could be a mobile phone, smart phone, personal digital assistant, tablet computer, and the like. Connected device 850 represents a device with a large screen 855. For example, connected device 850 could be a television screen (e.g., a smart television) or another device connected to a television (e.g., a set-top box or gaming console) or the like. One or more of the connected devices 830, 840, 850 can include touchscreen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 800. For example, the cloud 810 can provide services for one or more computers (e.g., server computers) without displays.

Services can be provided by the cloud 810 through service providers 820, or through other providers of online services (not depicted). For example, cloud services can be customized to the screen size, display capability, and/or touchscreen capability of a particular connected device (e.g., connected devices 830, 840, 850).

In example environment 800, the cloud 810 provides the technologies and solutions described herein to the various connected devices 830, 840, 850 using, at least in part, the service providers 820. For example, the service providers 820 can provide a centralized solution for various cloud-based services. The service providers 820 can manage service subscriptions for users and/or devices (e.g., for the connected devices 830, 840, 850 and/or their respective users).

### Example 11

### Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 6, computer-readable storage media include memory 620 and 625, and storage 640. By way of example and with reference to FIG. 7, computer-readable storage media include memory and storage 720, 722, and 724. The term computer-readable storage media does not include communication connections (e.g., 670, 760, 762, and 764) such as signals and carrier waves.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. We therefore claim as our invention all that comes within the scope and spirit of the claims.

We claim:

1. A method, implemented at least in part by a computing device, for automatically determining a touch input mode, the method comprising:
receiving, by the computing device, initiation of a touch action by a user;
automatically detecting, by the computing device, whether the touch action is received from the user using a finger or using an object;
when the touch action is automatically detected to be using a finger:
switching the touch input mode to a finger touch input mode; and
receiving touch input from the user in the finger touch input mode; and
when the touch input is automatically detected to be using an object:
switching the touch input mode to an object touch input mode that uses digital ink; and
receiving touch input from the user in the object touch input mode using digital ink.

2. The method of claim 1 wherein the object touch input mode only uses digital ink for input received in the object touch input mode.

3. The method of claim 1 wherein the object used by the user is a conductive object.

4. The method of claim 1 wherein touch input received in the finger touch input mode performs user interface manipulation actions.

5. The method of claim 1 wherein automatically detecting whether the touch action is received from the user using a finger or using an object comprises:
receiving at least a size parameter indicating a diameter of a touch area associated with the touch action; and
comparing the diameter of the touch area to one or more pre-determined thresholds.

6. The method of claim 1 further comprising:
while in the object touch input mode:
providing haptic feedback, the haptic feedback comprising one or more of vibration haptic feedback and electrostatic haptic feedback.

7. The method of claim 1 further comprising:
while in the object touch input mode:
providing haptic feedback, the haptic feedback comprising one or more of vibration haptic feedback and electrostatic haptic feedback; and
providing audio feedback;
wherein the haptic feedback and the audio feedback simulate writing on paper.

8. The method of claim 1 further comprising:
while in the finger touch input mode:
providing feedback according to a first feedback model; and
while in the object touch input mode:
providing feedback according to a second feedback model;
wherein the first feedback model is different form the second feedback model.

9. The method of claim 1 further comprising:
when in the finger touch input mode:
receiving, from the user, a manual selection of a digital ink input setting; and
receiving, from the user, digital ink content using the user's finger.

10. A computing device comprising:
a processing unit;
memory; and
an touch-enabled input device supporting touch by a finger and touch by a conductive object;
the computing device configured to perform operations for automatically determining a touch input mode, the operations comprising:
receiving initiation of a touch action by a user;
automatically detecting whether the touch action is received from the user using a finger or using an object;
when the touch action is automatically detected to be using a finger:
switching the touch input mode to a finger touch input mode; and
receiving touch input from the user in the finger touch input mode; and
when the touch input is automatically detected to be using an object:
switching the touch input mode to an object touch input mode that uses digital ink; and
receiving touch input from the user in the object touch input mode using digital ink.

11. The computing device of claim 10 wherein the object touch input mode only uses digital ink for input received in the object touch input mode.

12. The computing device of claim 10 wherein touch input received in the finger touch input mode performs user interface manipulation actions.

13. The computing device of claim 10 wherein automatically detecting whether the touch action is received from the user using a finger or using an object comprises:
receiving at least a size parameter indicating a diameter of a touch area associated with the touch action; and
comparing the diameter of the touch area to one or more pre-determined thresholds.

14. The computing device of claim 10 further comprising:
while in the object touch input mode:
providing haptic feedback, the haptic feedback comprising one or more of vibration haptic feedback and electrostatic haptic feedback; and
providing audio feedback;
wherein the haptic feedback and the audio feedback simulate writing on paper.

15. The computing device of claim 10 further comprising:
while in the finger touch input mode:
providing feedback according to a first feedback model; and
while in the object touch input mode:
providing feedback according to a second feedback model;
wherein the first feedback model is different form the second feedback model.

16. The computing device of claim 10 further comprising:
when in the finger touch input mode:
receiving, from the user, a manual selection of a digital ink input setting; and
receiving, from the user, digital ink content using the user's finger.

17. A computer-readable storage medium storing computer-executable instructions for causing a computing device to perform a method for automatically determining a touch input mode, the method comprising:
receiving initiation of a touch action by a user;
automatically detecting whether the touch action is received from the user using a finger or using a conductive object;
when the touch action is automatically detected to be using a finger:
switching the touch input mode to a finger touch input mode; and
receiving touch input from the user in the finger touch input mode; and
when the touch input is automatically detected to be using a conductive object:
switching the touch input mode to an object touch input mode that uses digital ink, wherein the object touch input mode only uses digital ink for input received in the object touch input mode;
receiving touch input from the user in the object touch input mode using digital ink;
providing haptic feedback while in the object touch input mode, the haptic feedback comprising one or more of vibration haptic feedback and electrostatic haptic feedback; and
providing audio feedback while in the object touch input mode;
wherein the haptic feedback and the audio feedback simulate writing on paper while in the object touch input mode.

18. The computer-readable storage medium of claim 17 wherein touch input received in the finger touch input mode performs user interface manipulation actions.

19. The computer-readable storage medium of claim 17 wherein automatically detecting whether the touch action is received from the user using a finger or using an object comprises:
receiving at least a size parameter indicating a diameter of a touch area associated with the touch action; and
comparing the diameter of the touch area to one or more pre-determined thresholds.

20. The computer-readable storage medium of claim 17 further comprising:
while in the finger touch input mode:
only providing audio feedback; and
while in the object touch input mode:
providing at least haptic and audio feedback.
